(19) United States
(12) Patent Application Publication
(10) Pub. No.: US 2026/0171096 A1
(43) Pub. Date: Jun. 18, 2026

(54) MULTI-PERSON INTERACTION WITH A WEARABLE DEVICE

(71) Applicant: GOOGLE LLC, Mountain View, CA (US)

(72) Inventors: Kathleen Alexandra Bryan, Mountain View, CA (US); Shiblee Hasan, Santa Clara, CA (US)

(21) Appl. No.: 19/418,726

(22) Filed: Dec. 12, 2025

Related U.S. Application Data
(60) Provisional application No. 63/733,233, filed on Dec. 12, 2024.

(51) Int. Cl. G10L 17/22; G10L 17/02; H04R 1/10; H04R 5/033; H04S 7/00

(52) U.S. Cl. CPC G10L 17/22; G10L 17/02; H04R 1/1083; H04R 5/033; H04S 7/30; H04R 2460/01; H04S 2400/11

(57) ABSTRACT

According to at least one implementation, a method includes receiving, by at least one audio input device on a wearable device, audio from a user. The method further includes determining a direction associated with the user relative to the wearable device based on the audio and determining a response to the audio. The method also provides for determining an audio configuration for at least one audio output device on the wearable device based on the direction and providing, by the at least one audio output device, the response to the user based on the audio configuration.

### CROSS-REFERENCE TO RELATED APPLICATION

This application claims priority to U.S. Provisional Ser. No. 63/733,233, filed on Dec. 12, 2024, entitled “MULTI-PERSON INTERACTION WITH A PROCESSOR”, the disclosure of which is incorporated by reference herein in its entirety.

### BACKGROUND

Wearable computing devices, such as smart glasses, head-worn displays, or other extended reality (XR) devices, have become increasingly prevalent. These devices are typically designed to be worn by a user, much like conventional eyeglasses, and integrate various electronic components into a compact, portable form factor. Such components often include one or more processors, memory, communication interfaces, and different input and output peripherals. For example, a wearable device may include a display system, such as a projector that directs images onto a lens or a transparent display integrated within the lens itself, to provide the user with augmented reality (AR) content overlaid on their view of the physical world. The device may also incorporate an array of sensors, cameras, microphones, and speakers to perceive its environment and interact with the user.

A primary mode of interaction with these wearable devices is through voice commands. A user, often referred to as the wearer, can speak to the device to issue commands, ask questions, or otherwise engage with a digital assistant or an artificial intelligence (AI) agent. The device's microphones capture the user's speech, which is then processed to understand the user's intent. In response, the device can generate and deliver content back to the user. This output can be auditory, such as a spoken response played through speakers aimed at the user's ears, or visual, with text or graphics displayed on the device's screen. This interaction paradigm enables a hands-free, personal computing experience in which the user can access information and digital services while remaining engaged with their physical surroundings.

### SUMMARY

This disclosure describes systems and methods for enabling multi-person interaction with a single wearable computing device. In one implementation, a wearable device equipped with an array of audio input devices, such as microphones, receives audio from a user, who may be the person wearing the device or a bystander. The device's processor determines a direction associated with the user by analyzing the audio data from the microphone array. After an artificial intelligence (AI) agent determines an appropriate response to the user's audio input, the system determines an audio configuration for its audio output devices based on the user's direction. This configuration allows the device to provide the response by directing the sound primarily toward the user who made the initial request, using techniques like spatial audio to create a targeted interaction.

The system is further capable of managing simultaneous conversations with multiple users. For instance, the wearable device can receive and distinguish audio from a first user (e.g., the wearer) and a second user (e.g., a bystander) by determining the direction of each user. The device can process both audio inputs, generate distinct responses for each, and then use different audio configurations to deliver each response to the correct person. The first response can be delivered via internal speakers to the wearer, while the second response is delivered via external, directional speakers to the bystander. To enhance the experience, the system can apply noise cancellation to minimize the audibility of a response for non-intended listeners. In some implementations, determining the response may involve communicating with a remote service, and for the wearer, the response may be provided visually on the device's display.

In some aspects, the techniques described herein relate to a method including: receiving, by at least one audio input device on a wearable device, audio from a user; determining a direction associated with the user relative to the wearable device based on the audio; determining a response to the audio; determining an audio configuration for at least one audio output device on the wearable device based on the direction; and providing, by the at least one audio output device, the response to the user based on the audio configuration.

In some aspects, the techniques described herein relate to a computing system including: a computer-readable storage medium; at least one processor operatively coupled to the computer-readable storage medium; and program instructions stored on the computer-readable storage medium that, when executed by the at least one processor, direct the computing system to perform a method, the method including: receiving, by at least one audio input device on a wearable device, audio from a user; determining a direction associated with the user relative to the wearable device based on the audio; determining a response to the audio; determining an audio configuration for at least one audio output device on the wearable device based on the direction; and providing, by the at least one audio output device, the response to the user based on the audio configuration.

In some aspects, the techniques described herein relate to a computer-readable storage medium having program instructions stored thereon that, when executed by at least one processor, direct the at least one processor to perform a method, the method including: receiving, by at least one audio input device on a wearable device, audio from a user; determining a direction associated with the user relative to the wearable device based on the audio; determining a response to the audio; determining an audio configuration for at least one audio output device on the wearable device based on the direction; and providing, by the at least one audio output device, the response to the user based on the audio configuration.

The details of one or more implementations are outlined in the accompanying drawings and the description below. Other features will be apparent from the description, drawings, and claims.

### BRIEF DESCRIPTION OF THE DRAWINGS

FIG. 1 illustrates a wearable device for multi-person interactions according to an implementation.

FIG. 2 illustrates a wearable device for multi-person interactions according to an implementation.

FIG. 3 illustrates a method of operating a wearable device according to an implementation.

FIG. 4 illustrates an operational scenario of processing voice requests from multiple users according to an implementation.

FIG. 5 illustrates an operational scenario of processing voice requests from multiple users according to an implementation.

FIG. 6 illustrates a method of operating a wearable device to manage voice requests from multiple users according to an implementation.

FIG. 7 illustrates a computing system to manage voice requests according to an implementation.

### DETAILED DESCRIPTION

The systems and techniques described herein solve the common challenge of making wearable AI assistants useful for more than just the person wearing them. Conventionally, smart glasses are a strictly personal device. The described technology transforms them into a shared conversational tool by enabling them to distinguish between different speakers in a room and provide targeted, private audio responses. For instance, in a collaborative work environment, a designer wearing the glasses could ask for a specific design file and get a private audio response, while a colleague next to them could ask the same glasses to perform a unit conversion and receive a separate, directed answer. This allows for natural, simultaneous interaction with a single AI assistant from multiple users, improving workflow and collaboration.

Specifically, the system and techniques described herein address the technical problem of the single-user limitation inherent in conventional wearable computing devices. Currently, devices such as smart glasses are designed so that an AI agent or service can interact exclusively with the person wearing the device, preventing bystanders from engaging in concurrent conversations with the same AI. The described invention overcomes this limitation by providing a system in which a single wearable device simultaneously captures, distinguishes, and processes speech from multiple users (e.g., the wearer and one or more bystanders). Using a microphone array for audio source localization and directional speakers for targeted audio output, the device can manage separate conversational threads, delivering private or directed AI-generated responses to the appropriate individuals (i.e., multiple users), thereby transforming the device from a personal assistant into a shared conversational hub.

Wearable computing devices, such as smart glasses, head-mounted displays (HMDs), or other augmented reality (AR) and extended reality (XR) systems, are designed to be worn by a user, often in a form factor similar to conventional eyeglasses. These devices integrate a suite of electronic components, including processors, memory, communication interfaces, and various sensors, such as cameras and microphones. A key feature of many wearable devices is a display system, which may include a micro-projector that projects an image onto a lens or a transparent display embedded within the lens. This display system enables the device to present computer-generated information, such as text, graphics, or images, as an overlay on the user's natural field of view, thereby creating an augmented reality experience.

Interaction with such wearable devices can be centered around a single user, the wearer. A standard input modality is voice, in which the wearer issues verbal commands or queries to an integrated digital assistant or artificial intelligence (AI) agent. The device's microphones are configured to capture the wearer's speech, which is then processed to interpret the user's intent. In response, the device generates output delivered back to the wearer. This output can be auditory, such as a spoken response from the AI agent delivered through speakers directed toward the wearer's ears, or visual, where information is rendered on the device's display. This paradigm facilitates a personal, hands-free computing experience, allowing the user to access digital content and services while remaining engaged with their physical surroundings. However, this paradigm is inherently limited to the single wearer. A technical problem with existing devices is that they are designed to process input only from the person wearing the device and deliver output meant solely for that individual. This design prevents other people in the wearer's vicinity, such as a bystander, from concurrently interacting with the device's AI agent.

As at least one technical solution to this problem, a system can be configured to enable a single wearable device to support simultaneous interactions with an AI agent from multiple people. The device can be designed to recognize and process speech from both the person wearing the device and from other people in the vicinity, such as bystanders. This allows a group of people to engage with the same AI, turning a personal device into a shared assistant. For example, the wearer could ask the AI for directions while a friend standing next to them could ask a separate question about the weather, and the device would handle both requests.

To achieve this, the device uses an array of microphones and speakers. The microphones can determine the direction a voice is coming from, allowing the device to distinguish between speech from the wearer and speech from a bystander. As used herein, the term direction refers to the calculated spatial origin of a user's voice relative to the wearable device. The direction can be determined by the device's processor, which analyzes the differences in the time it takes for sound to reach each microphone in an array. This directional data allows the system not only to distinguish one speaker from another but also to direct the corresponding audio response back to the specific location of the speaker. Once the AI generates a response, it is delivered through directional speakers. An internal speaker might provide a private answer to the wearer, while an external speaker can produce a different answer specifically to the bystander who asked the question. This system of directional audio input and output, often combined with noise cancellation, enables clear, separate, and simultaneous conversations with the AI among multiple users.

In some implementations, a direction can also refer to a set of spatial coordinates or a vector representing the calculated origin of a user's voice relative to a coordinate system of the wearable device. In some implementations, a direction can be a data parameter that links a detected audio source to a specific spatial location, enabling the system to both attribute received audio to a user at that location and target an audio response back to the same location. In some implementations, a direction can be the result of an audio source localization process, which identifies the angular and/or positional origin of a sound relative to the wearable device, used for speaker identification and targeted audio output.

As used herein, the term spatial audio encompasses a range of audio processing technologies designed to produce and control the directionality of sound propagated from a device. Such technologies may include, without limitation, audio beamforming, wave field synthesis, and other computational audio techniques that manipulate signals provided to a plurality of speakers to create a targeted auditory experience. The goal of these technologies is to deliver sound to a listener at a specific spatial location while minimizing audibility at other locations (i.e., provide audio primarily to a user in a set of users).

In some implementations, the wearable device can be configured with a set of microphones. This audio capture can be accomplished through a microphone array integrated into the frame of the device. For example, the device may feature at least four microphones strategically positioned to perceive sound from various directions. Some microphones, such as a pair near the temples, can be primarily directed toward the wearer to capture their speech preferentially. Other microphones can be oriented outward to capture ambient sounds and, more specifically, the speech of other individuals in the vicinity. This multi-microphone configuration allows the device to receive multiple, distinct audio channels simultaneously, each containing a slightly different representation of the soundscape based on the microphone's position and orientation.

To determine the source of a particular utterance and distinguish between the wearer and a bystander, the system can be configured to analyze the directionality of the incoming audio signals. By processing the raw data from the microphone array, the device can perform a technique known as triangulation or beamforming. This process involves measuring the minute differences in the time it takes for a sound to reach each microphone. Based on these time-of-arrival differences, the system's processor can calculate the direction and location from which a voice originated relative to the device. This spatial information allows the device to reliably associate a specific stream of speech with a particular person in the environment.

In addition to spatial location, the device can employ audio processing to analyze the tonal characteristics of each voice as a secondary method of speaker identification. The system can create a unique voice profile for each speaker based on acoustic features like pitch, frequency, and cadence. By combining this tonality analysis with the directional data, the system can achieve a highly robust method for speaker diarization—the process of partitioning an audio stream into segments according to speaker identity. This dual approach ensures that even in a dynamic conversation with multiple participants, the device can accurately attribute each query or comment to the correct individual before routing it to the AI agent for processing.

When speech is received from a person, the system can use an agent to process the speech input and determine output content. In some examples, the agent can process the identified speech streams, which serve as prompts, by first converting the audio into a machine-readable format, such as text, using an automatic speech recognition (ASR) module. This transcribed text, along with associated metadata identifying the speaker (e.g., “wearer” or “bystander 1”) in some examples, is then provided as input to an AI model. The AI model is configured to comprehend the natural language query, discern the user's intent, and generate a relevant response. For instance, if the wearer asks for directions and a bystander asks about the weather, the system creates two distinct processing threads, each with its own context, ensuring that the subsequently generated content is correctly mapped back to the original person that generated the query.

In some implementations, the AI agent can use a large language model (LLM), a type of machine-learning model configured (i.e., trained) on vast quantities of text and speech data. Such a model can be configured to use deep learning techniques to predict and generate human-like text or speech based on the input prompt. When the model receives a transcribed query, the model can analyze the semantic content and structure to formulate a coherent and contextually appropriate answer. The system can maintain separate conversational contexts for each user, allowing the model to handle follow-up questions or remember previous interactions with both the wearer and the bystander. The generated output, which may be a text string or a synthesized audio file, is then prepared for delivery.

In some implementations, the AI model may not run directly on the wearable device due to computational and memory constraints. Instead, the system can employ a split computing architecture where the model is hosted on a remote server or a connected companion device, such as a smartphone. In this configuration, the wearable device captures the raw audio from its microphone array and transmits the audio, or a pre-processed version of the audio, to the remote system via a wireless communication interface. The server handles intensive tasks, such as speech-to-text conversion and AI model execution. Once the response content is generated, the response is sent back to the wearable device, which then routes the audio to the appropriate internal or external speakers for output. This approach allows the wearable device to remain lightweight and power-efficient while leveraging the processing power of more capable remote computing resources.

After generating the response, the system routes the generated content to the appropriate output device or devices based on the identity and location of the person who made the initial query. This mapping is enabled by metadata that was associated with the input audio stream during the initial speaker diarization process. For a response intended for the wearer, the system directs the audio signal to the internal speakers, such as those positioned near the wearer's ears, providing a private listening experience. Conversely, for a response intended for a bystander, the system utilizes the external speakers and may employ audio beamforming techniques to direct the sound precisely toward the bystander's calculated location, minimizing auditory leakage to others and enhancing clarity for the intended recipient.

In some implementations, the output is not limited to an auditory format. The system can be configured to determine whether a response is better suited for visual presentation, particularly for the wearer who has access to the device's display. This determination can be based on a variety of factors, including explicit user preferences, the type of content generated by the AI agent, or the ambient environmental conditions. For example, complex information such as map directions, a list of search results, or a detailed image is more effectively conveyed visually. In such cases, instead of or in addition to an audio response, the content is rendered as text or graphics and presented on the wearable device's integrated display system, appearing in the wearer's field of view.

The selection of the output modality and specific output device is governed by a content delivery logic or an output management module within the system's processor. This module can operate based on a predefined set of rules or a lightweight decision-making model that processes several inputs in real-time. These inputs can include the speaker identifier (e.g., “wearer” or “bystander 1”), the spatial coordinates associated with that speaker, the content type of the AI-generated response (e.g., text string, audio file, image data), pre-configured user settings (e.g., “always display text”), and data from onboard sensors, such as the ambient noise level detected by the microphone array. Based on these parameters, the module selects the optimal audio output configuration, ensuring the right information is delivered to the right person in the most effective format.

In some implementations, the system's capabilities can extend beyond simple one-to-one interactions to support selective, multi-recipient responses. The device can be configured to deliver a single AI-generated response to a designated subset of users within a group, while actively preventing other users in the same group from hearing the response. For example, in a scenario with three users—a wearer and two bystanders—a query from one user could result in a response audible only to two of the three. This allows for the creation of shared, yet controlled, conversational subgroups, turning the device into a flexible intermediary for group communication.

The selection of the intended recipients for a response can be determined through several mechanisms. In one implementation, the selection is triggered by an explicit instruction within a user's verbal request. A user might say, “Device, tell me and bystander A the project status,” which the AI agent is configured to parse to identify both the query and its intended audience. The system then tags the generated response with identifiers for both the original speaker and the specified bystander. In another implementation, the selection can be context-driven, based on pre-established user profiles or system-managed group affiliations. For example, if the wearer and one bystander are known members of a specific team, a query related to that team's work may cause the system to automatically direct the response to both members, while excluding the third, non-affiliated bystander.

Once the set of intended recipients is determined, the output management module generates a corresponding audio configuration to execute the selective delivery. Using the previously calculated spatial coordinates for each user, the system employs audio beamforming to create multiple directed sound beams from its external speakers—one for each intended bystander. If the wearer is also an intended recipient, the audio is concurrently routed to the internal speakers. For the excluded user, the system not only avoids directing an audio beam toward their location but may also apply active noise cancellation. This involves using the microphone array to detect sound leakage and generating an anti-phase signal to create a zone of acoustic quiet around the excluded individual, thereby ensuring the privacy and relevance of the shared response.

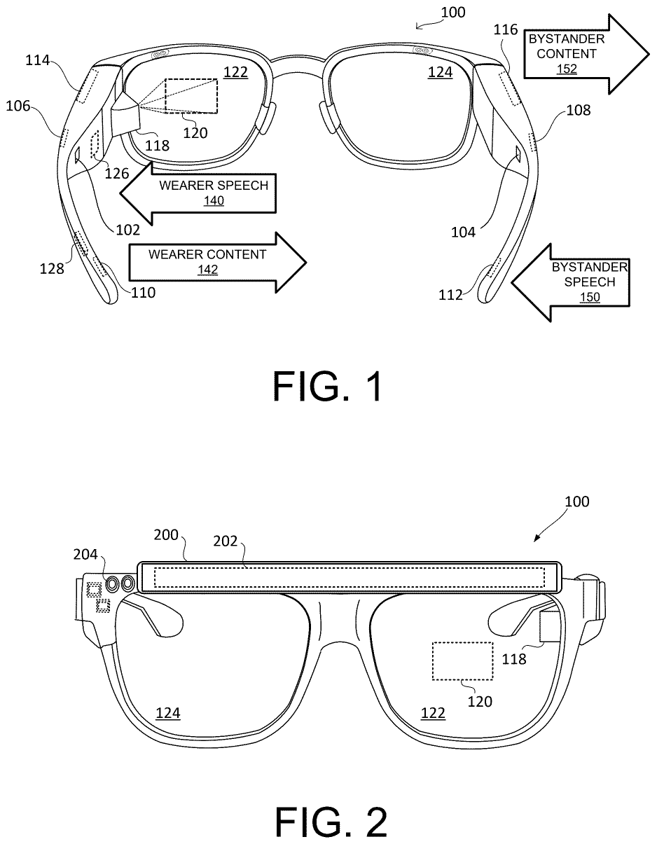

FIG. 1 illustrates a wearable device 100 for multi-person interactions according to an implementation. The present example assumes that a person (called the “wearer”) is wearing the wearable device 100, and that at least one other person (called the “bystander”) who is not wearing the wearable device 100 is present in the vicinity of the wearer. The wearable device 100 is shown here in a rear view, and the wearer and bystander are not shown for simplicity.

In operation, the wearable device 100 is configured to function as a shared personal assistant, permitting both the wearer and a nearby bystander to interact with an AI agent simultaneously. Wearable device 100 can use an array of microphones (e.g., microphones 102, 104, 106, and 108) to capture and distinguish between speech originating from the wearer and speech from the bystander. After an AI agent processes these separate spoken requests, the device uses different sets of speakers from speakers 110, 112, 114, and 116 to deliver the corresponding answers to the correct person. For instance, the wearer could ask the AI agent for directions to a location while a friend standing next to them asks a separate question about the weather. The wearable device 100 can process both queries concurrently, delivering navigational instructions to the wearer via internal speakers while providing the weather forecast to bystanders via external, directional speakers.

The wearable device 100 can have multiple microphones and/or multiple speakers. In some implementations, an array of microphones on the wearable device 100 can capture audio from various directions relative to the wearable device 100 and can also distinguish audio based on its direction of origination. For example, microphones 102 and 104 (e.g., embedded within, or located on, a portion of the wearable device, such as the arm of an eyeglasses frame) can be directed toward the wearer and, as such, can detect mostly or only speech from the wearer (wearer speech 140). As another example, microphones 106 and 108 can be directed away from the wearer (e.g., embedded within, or located on, a portion of the wearable device, such as the arm of an eyeglasses frame) and can capture speech from, and recognize the respective locations of, one or more bystanders (e.g., bystander speech 150). In some implementations, an array of speakers of the wearable device 100 can allow audio to be output in any direction relative to the wearable device 100. For example, speakers 110 and 112 can be internal speakers of the wearable device 100 (e.g., embedded within, or located on, a portion of the wearable device, such as the arm of an eyeglasses frame), such that the sound they output is essentially perceived only by the wearer. This is demonstrated as wearer content 142. Further, speakers 114 and 116 can be external speakers of the wearable device 100 (e.g., embedded within, or located on, a portion of the wearable device, such as the arm of an eyeglasses frame), such that the sound they output is essentially perceived only by the bystander (e.g., with some noise canceling performed toward the wearer). This is demonstrated as bystander content 152.

The wearable device 100 receives speech from multiple individuals by leveraging its integrated microphone array, which includes inward-facing microphones (e.g., 102, 104) optimized to capture wearer speech 140 and outward-facing microphones (e.g., 106, 108) designed to capture bystander speech 150. To distinguish between these sources, the device's processor employs advanced audio source localization techniques. By analyzing the time-of-arrival differences of sound waves across the spatially distributed microphones, the system can perform triangulation or beamforming to calculate the precise direction and approximate distance of each speaker. This spatial data allows the device to reliably separate the wearer's voice, which originates from a consistent, proximate location, from the voices of one or more bystanders located in the surrounding environment.

Once the distinct audio streams for wearer speech 140 and bystander speech 150 are isolated, they are processed by an AI agent. This process can begin with an ASR process that transcribes the spoken words into text. This text, along with metadata identifying the speaker (e.g., “wearer” or “bystander 1”) and, in some examples, the bystander's spatial location, is then sent as a prompt to a model or LLM. To manage computational load, this processing may occur within a split computing architecture, where the wearable device 100 transmits the audio data to a more powerful remote server or a connected companion device where the LLM is executed. The system maintains separate conversational contexts for each user, allowing the AI agent to process simultaneous queries and generate contextually appropriate responses for each individual.

After the AI agent (or service) generates a response, the system delivers the output to the intended recipient via a sophisticated output management process. For a response intended for the wearer, the content is routed as wearer content 142 to internal speakers (e.g., 110, 112), providing a private audio experience. For a response intended for a bystander, the content is routed as bystander content 152 to external speakers (e.g., 114, 116). These external speakers can use audio beamforming technology to direct sound to the bystander's triangulated location, enhancing clarity for the recipient while minimizing disruption to others. Furthermore, the system can perform active noise cancellation, ensuring that bystander content 152 is attenuated for the wearer and vice versa. For the wearer, the output is not limited to audio and may be displayed using AR display device 118.

As further demonstrated in FIG. 1, wearable device 100 can include an AR display device 118. The AR display device 118 can use any of various techniques to present AR content 120 to the wearer. In some implementations, the AR display device 118 includes a projector configured to display the AR content 120 onto either of lenses 122 or 124 of the wearable device 100 for observation by the wearer. In some implementations, the AR display device 118 can include one or more transparent prisms, and the AR display device 118 can project the AR content 120 onto the transparent prism to direct the visual content into the wearer's eye(s). The AR content 120 can be any type of content that can be visually output by the AR display device 118.

The wearable device 100 can facilitate haptic input and/or haptic output. In some implementations, a haptic output device 126 can be placed in or on the housing of the wearable device 100 (e.g., in the frame of a pair of eyeglasses). The haptic output device 126 can make use of any of various approaches for creating an experience of touch by the wearer. In some implementations, operation of the haptic output device 126 involves applying vibration (e.g., by an eccentric rotating mass) and/or pressure (e.g., by a transducer) to the wearer's body. For example, to inform the wearer that a bystander is seeking to interact with the AI agent through the wearable device 100, a cue can be generated using the haptic output device 126. As another example, the wearable device 100 can provide a cue to the wearer in response to the wearable device 100 being oriented to face towards a location of another person (e.g., the bystander). For example, when the wearer has limited eyesight this can allow them to recognize where other people are located.

In some implementations, a haptic input device 128 can be placed in or on the housing of the wearable device 100 (e.g., in the frame of a pair of eyeglasses). The haptic input device 128 can make use of any of various approaches for recognizing a touch by the wearer. In some implementations, the haptic input device 128 includes an inertial measurement unit (IMU) and/or capacitive/resistive touch sensing that detects the wearer's touch. In some implementations, the wearable device 100 can cue the wearer regarding something (e.g., that a bystander seeks access to the AI agent) and the wearer can approve the access by tapping on or touching the haptic input device 128.

Noise canceling can be performed. In some implementations, the bystander speech and/or the bystander AI content can be canceled from the wearer's audio. For example, having multiple external microphones (e.g., at least the microphones 106 and 108) that register the bystander speech can allow more efficient noise canceling. Also or instead, the wearer speech and/or the wearer AI content can be canceled from the bystander's audio. For example, having multiple internal microphones (e.g., at least the microphones 102 and 104) that register the wearer speech can allow more efficient noise canceling. Other approaches can be used.

In some implementations, a device can support multi-party conversations with an AI agent, effectively acting as a shared personal assistant. This can allow a person wearing a wearable device to ask the AI agent for directions while a friend beside them inquires about the weather. The wearable device, using spatial audio and noise cancellation, may understand both questions and deliver separate answers to each of you through the appropriate speakers—internal for the wearer, external and directional for the nearby person. In another scenario, at a dinner party someone across the table may ask someone else's wearable device, “What's the capital of Australia?” The wearable device could process the question, answer it discreetly to the wearer through the internal earpiece, and then relay the same answer externally, directing the sound towards the person who asked, almost as if the wearable device itself were participating in the conversation. Or consider the wearable device placed on a table, acting as a central AI hub. People around the table might ask questions, with the wearable device responding through directional audio, ensuring each person clearly hears their answer as if engaged in a natural conversation.

The present subject matter could rely on a combination of features. An array of microphones might capture sound from all directions, allowing the wearable device to pinpoint the source of each question. Noise cancellation could filter out background noise, ensuring clear voice capture even in busy environments. Small, directional speakers integrated into the wearable device might aim sound towards the intended recipient, allowing for private conversations even in public settings. AI could also be utilized to understand individual questions and maintain context, remembering who asked what and providing personalized responses to each user.

Implementations of the present subject matter could be built into products such as augmented reality glasses or a headset. This can include a hardware product such as two-way audio augmented reality glasses. As another example, an implementation could be partially an operating-system level functionality.

To distinguish wearer speech 140 from bystander speech 150, and to further differentiate between multiple bystanders, the wearable device can employ a combination of spatial audio analysis and voice characteristic profiling. In some implementations, the system utilizes the data from its microphone array (e.g., microphones 102, 104, 106, 108) to perform audio source localization. By measuring the minute time-of-arrival differences of a sound wave at each of the spatially separated microphones, a processor can triangulate the direction and approximate distance of the audio's origin. Wearer speech 140 will consistently originate from a predictable location immediately adjacent to the inward-facing microphones, while bystander speech 150 will originate from external locations. The same triangulation technique can distinguish between different bystanders, as each person will occupy a unique spatial coordinate relative to the device, allowing the system to associate a specific audio stream with a specific person. As a complementary or alternative technique, the system can perform audio processing to analyze the tonality of each voice. This involves creating a unique voiceprint for each speaker by identifying distinct acoustic features such as pitch, fundamental frequency, and cadence. By combining this tonality analysis with the directional data, the system can achieve a highly robust method for speaker diarization, accurately partitioning a continuous audio stream into segments attributed to the wearer and each unique bystander, even in a dynamic, multi-person conversation. This processing can occur on the device itself or on a remote server after transmitting the raw, multi-channel audio data.

In some implementations, live translation can be performed. Translation can be done from whatever language the other person is speaking to the preferred language of the wearer. In some implementations, this can be done when the output is also or instead directed at another person than the one who uttered the speech. For example, the bystander can request the AI agent to generate content (e.g., audio and/or AR content) for the wearer, which content can then be formulated using a language preferred by the wearer. As another example, the wearer can request the AI agent to generate content (e.g., audio and/or visual content, e.g., as described below) for the bystander, which content can then be formulated using a language preferred by the bystander.

In some implementations, the wearable device can function as a stationary, shared AI hub without being worn by any individual. For example, the device can be placed on a central surface, such as a table, in the middle of a group of people. The system can leverage its microphone array to perform audio source localization, distinguishing between different speakers around the table based on the directionality of their speech. When one person poses a query, the AI agent can process the request and formulate a response. The system can then use its directional speakers to beamform the audio output, directing the answer specifically to the location of the person who inquired. This allows multiple people to engage in separate, concurrent conversations with the AI agent, or to participate in a shared conversation where the device acts as a central resource, with each participant receiving clear, directed audio as if in a natural dialogue.

In some implementations, an AI can chime in during a conversation to give facts based on a conversation that is going on. The AI agent can become part of a layer that is contributing to the conversation. A person can be speaking Spanish, and another can be speaking English. They may be talking about something ambiguous. For example, they're referring to a concert they have been to, which is apparently very popular. They've assumed that the wearer already knows about it. An AI agent can determine whether the wearer attended that concert or read anything based on their digital history. In that case, instead of giving me an exact translation, the AI agent can add context to what the other person said. This can add richer context, helping with a better understanding of the other person.

The component that distinguishes speaker one from speaker two could be running either on the wearable device or remotely (e.g., on a server). For example, the device can triangulate using multiple microphones (e.g., four). Also, a raw audio stream from these microphones, four separate audio channels, can be sent to another device (e.g., a mobile phone or to the server) so that the device can also or instead determine how many speakers are engaged. Tonality and/or voice direction can be used to distinguish speakers from one another.

The functionality of the wearable device 100 as described herein can be enabled by an integrated computing system, which may be self-contained or operate as part of a split computing architecture in communication with a companion device or remote server. This system is architected around at least one programmable processor, such as a central processing unit (CPU), which is communicatively coupled to at least one memory, such as a non-transitory computer-readable medium including both volatile (e.g., RAM) and non-volatile (e.g., flash) storage. The processor is configured to execute machine-readable instructions stored in the memory to orchestrate the overall device operations, including managing the various input and output peripherals. To efficiently handle the intensive audio processing tasks, the system may further include specialized hardware such as a dedicated digital signal processor (DSP) or an audio codec with advanced processing capabilities. This specialized component can be responsible for the real-time execution of algorithms for noise cancellation, audio source localization via triangulation or beamforming from the microphone array data, and initial voice feature extraction for tonality analysis. In some implementations, an application-specific integrated circuit (ASIC) or a field-programmable gate array (FPGA) could be employed to provide hardware-accelerated, power-efficient performance for these specific computational tasks. A wireless communication interface, such as a Bluetooth or Wi-Fi transceiver, facilitates the transmission of processed audio streams to, and the reception of AI-generated content from, an external computing resource where a large language model may be executed. All these components, including the processor, memory, specialized processors, and communication interface, are interconnected via one or more buses, allowing them to work in concert to capture, process, and route data to enable simultaneous, multi-person interactions with an AI agent.

FIG. 2 shows another example of the wearable device 100 of FIG. 1. The wearable device 100 is shown in a view from the front. Here, the wearable device 100 has the AR display device 118 and also an external display device 200 that is visible to one or more bystanders. The external display device 200 can use any of various forms of display technology, including, but not limited to, light-emitting diode (LED) or liquid-crystal display (LCD) technology. That is, the wearable device 100 can use the AR display device 118 to present the AR content 120 that is visible to the wearer (e.g., on one or more of the lenses 122 or 124 or otherwise) and, also or instead, the wearable device 100 can use the external display device 200 to present content 202 to the bystander(s). In some situations, the AR content 120 and the content 202 can be different from each other (e.g., because they are responses to different questions posed to an AI agent by the wearer and the bystander, respectively). In other situations, the AR content 120 and the content 202 can be at least substantially identical to each other (e.g., to allow the wearer to perceive the content that the AI agent outputs to the bystander). The wearable device 100 can have at least one camera 204.

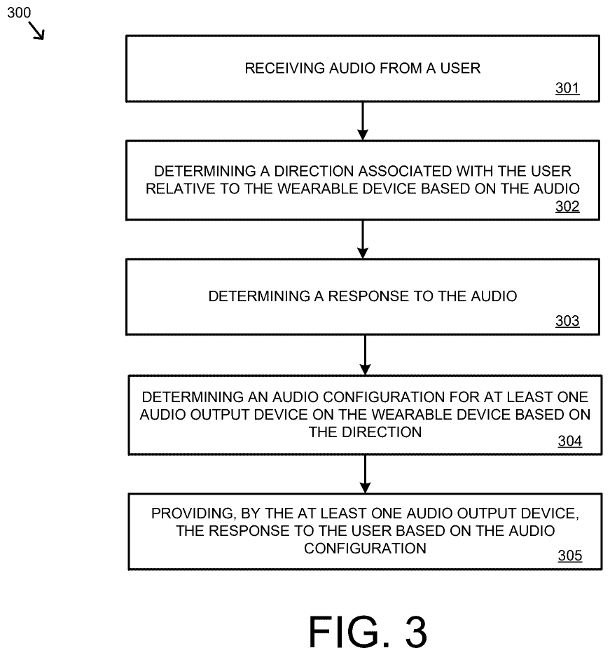

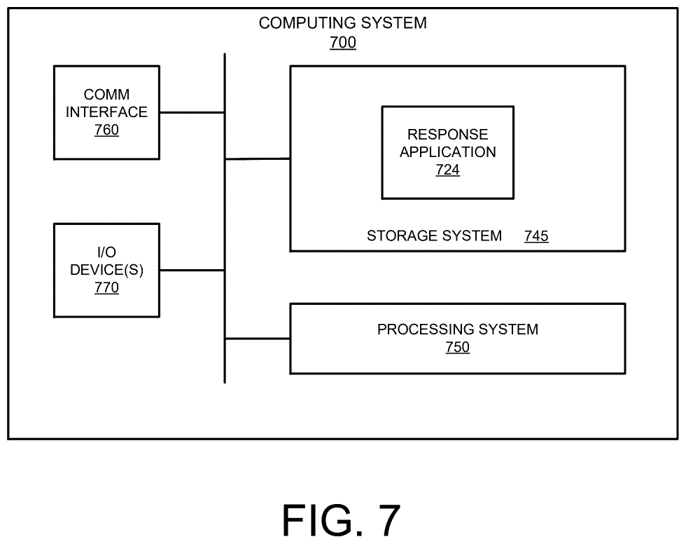

FIG. 3 illustrates a method 300 of operating a wearable device according to an implementation. The steps of method 300 can be performed by a wearable device, such as the wearable device 100 in the previous Figures. Method 300 can also be performed by computing system 700 of FIG. 7.

Method 300 includes receiving, by at least one audio input device on a wearable device, audio from a user at step 301. The user in this context can be any individual whose speech is intended for the wearable device, including the person actively wearing the device (the wearer) or another individual in the vicinity (a bystander). The audio input device is a transducer, such as a microphone, that converts acoustic energy in the form of sound waves into an electrical signal that can be processed by the device's processor. To enable advanced functions like spatial audio analysis, the wearable device can be equipped with an array of audio input devices, comprising multiple microphones that are spatially distributed across the device.

The positioning of these microphones within the array is strategic to facilitate the distinction between different speakers. For example, some microphones may be located on the inner surfaces of the device's frame, such as the arms or temples, to be preferentially oriented toward the wearer's mouth. Other microphones can be positioned on the outward-facing surfaces of the frame to better capture ambient sounds and, specifically, the speech originating from bystanders in the surrounding environment. This configuration allows the system to capture multiple, distinct audio channels simultaneously, which is a prerequisite for determining the directionality of the incoming sound.

Method 300 further includes determining a direction associated with the user relative to the wearable device based on the audio at step 302. This determination can be accomplished by the device's processor executing an audio source localization algorithm on the multi-channel audio data captured by the microphone array. Techniques such as triangulation or beamforming can be employed to analyze the minute time-of-arrival differences of the sound waves at each spatially separated microphone. Based on these differences, the system can calculate the direction from which the user's speech originated.

This spatial information is also used to determine the identity of the user, distinguishing between the wearer and one or more bystanders. The wearer's voice will consistently originate from a known, proximate location relative to the inward-facing microphones, whereas a bystander's voice will originate from an external location. To further enhance user identification, particularly in multi-bystander scenarios, the system can supplement this directional data with voice characteristic profiling. This involves analyzing the acoustic properties of the speech, such as pitch, frequency, and cadence, to create a unique voiceprint for each individual. By combining spatial localization with this tonality analysis, the system can perform robust speaker diarization, accurately attributing each utterance to the correct user. This processing can be performed locally on the device's processor or on a remote server as part of a split computing architecture.

Method 300 also provides for determining a response to the audio at step 303. This process can be handled by an AI agent in some examples. In some implementations, the system first converts the captured audio into a machine-readable format, such as text, using ASR module. This transcribed text, along with metadata identifying the user, can then be provided as a prompt to an AI model, such as an LLM, to generate a contextually relevant response. The determination of the response can occur locally on the wearable device's processor if the computational resources are sufficient. However, in other implementations, the system may employ a split computing architecture. In such a configuration, the wearable device transmits the audio data, or the transcribed text, to an external service, such as a remote server or a connected companion device (e.g., a smartphone). This external service, with its greater processing power, executes the AI model to generate the response content and then communicates it back to the wearable device for output. As used herein, the term service refers to a computing resource, external to the wearable device, that is configured to perform one or more computational tasks on behalf of the wearable device. The service comprises at least one processor and at least one memory and is configured to receive data from the wearable device, perform processing, and transmit a result back to the wearable device. Examples of such tasks include, but are not limited to, automatic speech recognition, execution of an artificial intelligence model such as a large language model, and the generation of response content. The service may be implemented on various hardware configurations, including a connected companion device such as a smartphone, a remote server, or a distributed cloud computing platform.

In some implementations, a response can be any content, whether auditory or visual, generated by an artificial intelligence agent in reply to a user's audio input. In some implementations, a response can be any output data, such as a synthesized audio file or graphical information, that is created by a computing system to address a query or command received in the form of audio from a user. In some implementations, a response can refer to the information formulated by a system, which may be based on execution of an AI model, for delivery to a user as a result of processing that user's audio.

Method 300 further provides for determining an audio configuration for at least one audio output device on the wearable device based on the direction at step 304. This determination involves selecting the appropriate audio output devices and specifying their operational parameters to ensure the response is delivered effectively to the intended user. Based on the direction calculated in step 302, the system can identify the user as either the wearer or a bystander. If the user is the wearer, the audio configuration routes the response to internal speakers directed toward the wearer's ears for a private experience. If the user is a bystander, the configuration selects the external speakers and employs audio beamforming techniques. This process uses the bystander's directional data to electronically steer the audio output, creating a focused beam of sound directed precisely at the bystander's location while minimizing audibility for others, including the wearer, for whom active noise cancellation may also be applied.

An audio output device, within the scope of this implementation, is an electroacoustic transducer that converts an electrical audio signal into corresponding sound waves perceptible by a human. The wearable device may be equipped with an array of such devices, which can include conventional micro-speakers, piezoelectric emitters, or bone conduction transducers integrated into the device's frame. These devices can be functionally categorized as internal audio output devices, positioned to deliver sound primarily to the wearer, and external audio output devices, oriented to project sound into the surrounding environment. The audio configuration governs the collective operation of one or more of these devices to control the amplitude, phase, and timing of their output signals, thereby enabling the spatial directionality of the generated sound.

In some implementations, an audio configuration can refer to a set of operational parameters for one or more audio output devices that specifies which devices to activate and how to modulate their output signals to achieve a targeted sound delivery. In some implementations, an audio configuration can be a set of instructions for a device's audio subsystem that dictates the selection of speakers and the signal processing, such as beamforming or noise cancellation, to be applied to an audio response to control its spatial properties. In some implementations, an audio configuration can be a specific arrangement and operational state of a device's audio output system, determined based on a user's location, to control the propagation of sound and direct an audio response to that user while minimizing its audibility to others.

Once the audio configuration is determined, method 300 includes providing, by the at least one audio output device, the response to the user based on the audio configuration step 305. This step involves the physical actuation of the audio output devices according to the parameters established in the audio configuration. The system's processor transmits the electrical signal representing the AI-generated response to the designated speakers. In the case of a response for a bystander, the system drives the external speakers, modulating the phase and amplitude of their individual outputs to electronically steer the resulting sound waves into a focused beam directed at the bystander's location. For a response intended for the wearer, the audio signal is routed to the internal speakers to provide a private listening experience. This process may also involve concurrent active noise cancellation to minimize the audibility of the response for any individuals other than the intended recipient.

In some implementations, where multiple users are interacting with the device, the steps of method 300 can be performed concurrently for each user to manage separate conversational threads. For instance, the system can receive a first audio stream from a first user (e.g., the wearer) and a second audio stream from a second user (e.g., a bystander). By performing speaker diarization (the process of partitioning an audio stream into segments according to speaker identity), the system distinguishes the two audio streams and initiates separate processing threads for each. This allows the AI agent to maintain a distinct conversational context for each user, enabling it to track and manage independent interactions without confusing the two dialogues. Consequently, the system can determine a first response for the first user and a second response for the second user, and then determine a unique audio configuration for each. For example, a first audio configuration can direct the first response to the wearer via internal speakers, while a second, different audio configuration can use beamforming to direct the second response to the bystander, facilitating simultaneous and distinct interactions with the AI agent.

In some implementations, the wearable device can support multiple languages. This functionality enables real-time translation during a conversation between the wearer and a bystander who speak different languages. For instance, when a bystander speaks in a first language, the device's ASR module can be configured to detect the language and transcribe the speech. The transcribed text can be sent to the AI agent with an instruction to translate the content into a target language, such as a pre-configured preferred language of the wearer. The AI agent can then generate a response in the wearer's language, which is subsequently delivered to the wearer through the internal speakers or display. Conversely, the system can perform the translation in the opposite direction, translating a query from the wearer into a language understood by the bystander and delivering the response in that language via the external, directional speakers. In some implementations, the AI agent can be configured to add contextual information to the translation. For example, if a speaker references a cultural event unfamiliar to the listener, the AI can supplement the translation with a brief explanation, thereby enriching the communication and improving mutual understanding between the participants.

In some implementations, the device determines whether a query is being made and attributes it to a specific user through a multi-stage process. The system can monitor the audio captured by its microphone array for a predefined wake word or activation phrase. Upon detection of this phrase, the system's processor immediately performs audio source localization by analyzing the data from the microphone array. Using triangulation or beamforming techniques, the processor calculates the direction of the voice that uttered the wake word. This directional information is then used to classify the speaker. If the voice originates from a location consistent with the wearer (e.g., proximate to the inward-facing microphones), the query is attributed to the wearer. If the voice originates from an external location, it is attributed to a bystander. To further refine this process, especially in environments with multiple bystanders, the system may also perform tonality analysis to create or match a unique voice profile for the speaker. This combined approach ensures that each query is accurately associated with its originator before being processed by the AI agent.

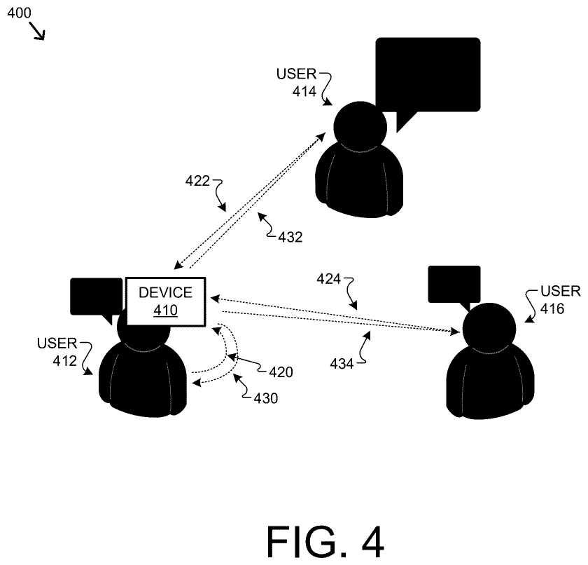

FIG. 4 illustrates an operational scenario 400 of processing voice requests from multiple users according to an implementation. Operational scenario 400 includes device 410 worn by user 412. Operational scenario 400 further includes user 414 and user 416 that are each representative of bystanders in proximity to user 412. Operational scenario 400 also includes requests 420, 422, and 424 that are received from users 412, 414, and 416, respectively, and responses 430, 432, and 434 that are provided to users 412, 414, and 416, respectively.

In operational scenario 400, the device 410 is configured to manage simultaneous interactions from multiple users by first capturing and separating their respective audio inputs. When user 412, user 414, and user 416 make their requests 420, 422, and 424, the device's integrated microphone array captures the incoming sound waves. The device's processor then performs audio source localization by analyzing the time-of-arrival differences of the speech at each microphone. This allows the system to triangulate the unique direction and location of each user relative to the device. For instance, request 420 from the wearer, user 412, will consistently originate from a known, proximate location, while requests 422 and 424 from bystanders user 414 and user 416 will originate from distinct external positions.

To further ensure accurate separation, the system can supplement this spatial data with tonality analysis, creating a unique voice profile for each speaker and enabling robust speaker diarization. This process partitions the incoming audio into three distinct streams, which are then processed in parallel. The device initiates a separate processing thread for each request, transcribing the audio to text and tagging it with the corresponding user identifier. These tagged requests are then provided as independent prompts to an AI agent, which maintains a separate conversational context for each user. This allows the AI to comprehend each query independently and formulate three distinct and contextually appropriate responses: response 430 for user 412, response 432 for user 414, and response 434 for user 416.

After generating the responses, the system's output management module ensures each is delivered to the correct individual. For response 430, intended for the wearer user 412, the system selects an audio configuration that routes the audio to internal speakers, providing a private listening experience. In some cases, this response may also be rendered visually (or rendered instead of provided audibly) on the device's AR display. For responses 432 and 434, intended for user 414 and user 416 (representative of bystanders), the system can be configured to use a different audio configuration. Device 410 engages the external speakers and employs audio beamforming technology, using the previously determined directional data to steer focused beams of sound precisely toward the respective locations of user 414 and user 416. This targeted delivery ensures that each bystander clearly hears their specific answer, while active noise cancellation can minimize auditory leakage to other users, enabling clear, parallel conversations with the AI agent.

For example, when user 414 makes request 422, the device 410 captures the audio and performs audio source localization to determine the direction associated with user 414. The request is processed by the AI agent, which formulates response 432. The system then determines an audio configuration that uses audio beamforming to direct the sound of response 432 from the external speakers precisely toward user 414, thereby delivering the content to the correct individual while minimizing disruption to user 412 and user 416.

To distinguish a direct query intended for the AI agent from ambient conversation between the users, the device 410 can be configured to employ an explicit trigger mechanism. In one implementation, the system continuously monitors the audio input for a predefined wake word or activation phrase. When the wake word is detected, the device's processor immediately performs audio source localization to identify the direction and identity of the speaker (e.g., user 412, user 414, or user 416). The speech that follows the wake word is then treated as a direct request for the AI agent. This process ensures that the device only engages when it is being explicitly addressed, preventing it from processing speech that is part of a human-to-human dialogue. In some implementations, this can be supplemented by other contextual cues, such as analyzing the semantic structure of the utterance to detect a question format or using camera data to determine if a user is looking at the device.

For example, user 412, user 414, and user 416 are colleagues collaborating on a project. User 412, wearing the device 410, might ask request 420, “Device, what are the key points from our last meeting?” Additionally, user 414, standing to the wearer's left, poses request 422, “Device, what is the current stock price for our competitor?” while user 416 makes request 424, “Device, translate the final approval into German.”

In response, the device 410 captures these three distinct voice inputs and performs audio source localization and speaker diarization to correctly attribute each request. The AI agent processes the requests in parallel, generating three unique responses. For user 412, response 430 is delivered as a text summary on the AR display, providing a private and detailed answer. For user 414, the system uses audio beamforming to direct response 432 (e.g., a spoken stock price) to their location. Concurrently, a separate audio beam delivers response 434 (e.g., a German translation to user 416). Active noise cancellation is applied to ensure that the audio responses for user 414 and user 416 do not disrupt user 412, thereby enabling three distinct, simultaneous, and private interactions with the single AI agent.

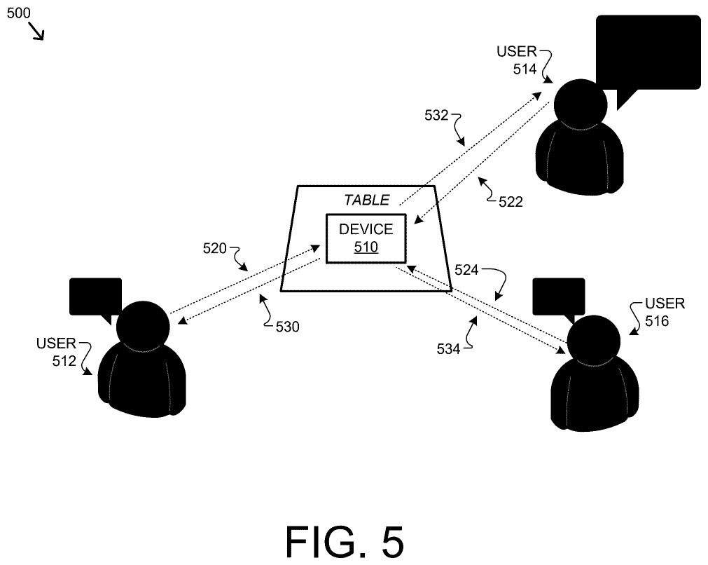

FIG. 5 illustrates an operational scenario 500 of processing voice requests from multiple users according to an implementation. Operational scenario 500 includes device 510, user 512, user 514, and user 516. Operational scenario 500 further includes requests 520, 522, and 524 that are received from users 512, 514, and 516, respectively. Operational scenario 500 also includes responses 530, 532, and 534 that are provided to users 512, 514, and 516, respectively.

In operational scenario 500, like the operations described in operational scenario 400, device 510 can be configured to function as a stationary, shared AI hub for multiple users. In this mode, the device 510 is not worn by any individual but is instead placed on a central surface, such as a table. This configuration transforms the personal wearable device into a communal conversational agent, capable of managing interactions with a group of people simultaneously. The core principles of audio source localization and directional audio output remain the same as in the worn scenario, but they are adapted to a stationary frame of reference.

When users 512, 514, and 516 make their respective requests 520, 522, and 524, the device 510 can leverage an integrated microphone array to capture the audio from various directions. The device's processor then executes an audio source localization algorithm, such as triangulation or beamforming, to analyze the time-of-arrival differences of the sound waves at each microphone. By doing so, the system can calculate the direction from which each request originated, allowing device 510 to reliably distinguish between the speech of user 512, user 514, and user 516. This spatial data, potentially supplemented by tonality analysis to create unique voice profiles, enables the system to perform speaker diarization and associate each request with its specific originator.

Once the individual requests are isolated and identified, the device processes them through an AI agent, which may reside locally or on a remote server. The system maintains separate conversational contexts for each user, allowing the AI to generate distinct and contextually appropriate responses 530, 532, and 534. To deliver these responses, the system's output management module determines an audio configuration for each one. Using the previously calculated directional data for each user, the device employs its external speakers to perform audio beamforming.

In some examples, device 510 can be configured to steer the sound waves electronically, creating focused beams of audio that are directed toward the locations of the intended recipients. For example, response 530 is directed specifically to user 512, response 532 is directed to user 514, and response 534 is directed to user 516. This targeted delivery ensures that each user clearly hears the answer to their specific query, minimizing auditory overlap and enabling multiple, parallel, and natural-feeling conversations with the single AI agent. This mode effectively allows the device to participate in a shared conversation as a central resource for the group.

In some implementations, a subset of users from users 512, 514, and 516 can be selected to receive a response. For example, based on a request from user 512, both user 512 and user 514 can receive an audible response, while user 516 does not. This selective delivery can be triggered by several conditions. One such condition is an explicit instruction within the request itself. For example, user 512 could state, “Device, tell me and user 514 what time our meeting is.” In this case, the AI agent can parse the request, identify the intended recipients (user 512 and user 514), and generate the response. The system would then determine an audio configuration that uses audio beamforming to create two distinct, directed sound beams—one for user 512 and one for user 514—while actively avoiding the direction of user 516.

Alternatively, the condition can be based on contextual information or pre-configured user profiles accessible by the AI agent. For instance, if user 512 and user 514 are known to be part of a specific group (e.g., a project team or family) and user 516 is not, a query from user 512 related to that group's shared information (e.g., “What are the next steps for Project X?”) would cause the system to limit the audience for the response. The system would identify the members of “Project X,” determine their locations, and deliver the audible response only to them, thereby excluding user 516 from the conversation. In another example, the exclusion can be based on user-defined privacy settings linked to individual voice profiles. The owner of the device may have configured a profile for user 516 with ‘guest’ permissions, which restricts access to the owner's personal data. If user 512 (the owner) were to ask a question like, “What's the next appointment on my calendar?”, the system would identify the query as relating to personal information. By checking the permission levels of the profiles associated with each detected user, the system would determine that user 516 is not authorized to receive the information. As a result, the audio configuration would be set to direct the response to user 512 and any other authorized users, like user 514, while ensuring user 516 is excluded.

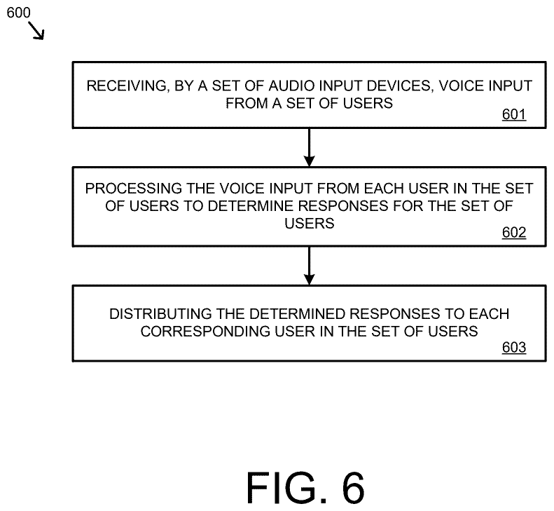

FIG. 6 illustrates a method 600 of operating a wearable device to manage voice requests from multiple users according to an implementation. The steps of method 600 can be performed by a wearable device, such as wearable device 100 of FIG. 1 or computing system 700 of FIG. 7.

Method 600 includes receiving, by a set of audio input devices, voice input from a set of users at step 601. This step involves the capture of acoustic energy from the environment by the wearable device's integrated microphone array. The “set of audio input devices” refers to multiple, spatially distributed microphones embedded within the device's frame. For instance, some microphones may be inward-facing to preferentially capture speech from the person wearing the device (the wearer), while others are outward-facing to capture ambient sounds, including the speech of other individuals (bystanders). The “set of users” can therefore include both the wearer and/or one or more bystanders who are simultaneously or sequentially interacting with the device. The system is configured to receive multiple, distinct audio streams from these microphones, providing the multi-channel data necessary for subsequent processing steps, such as audio source localization to distinguish between the different speakers.

Method 600 further includes processing the voice input from each user in the set of users to determine responses for the set of users at step 602. This multi-stage processing begins with speaker diarization, where the system distinguishes the voice input from each user. To accomplish this, the device's processor analyzes the multi-channel audio data captured in step 601. Using audio source localization techniques such as triangulation or beamforming, the processor calculates the direction of each voice by measuring the time-of-arrival differences of the sound waves at the spatially distributed microphones. This spatial data allows the system to associate each audio stream with a specific user (e.g., “wearer” or “bystander at 45 degrees”). The direction of each voice is calculated relative to the physical orientation of the wearable device, establishing a spatial map of the users from the device's own perspective. As a complementary technique, the system may also perform tonality analysis to create a unique voice profile for each speaker based on acoustic features like pitch and cadence, ensuring robust identification even in noisy environments.

Once the individual audio streams are isolated and attributed to specific users, each stream is converted into a machine-readable format. This is typically achieved using an ASR module or application, which transcribes the spoken words into text. This transcribed text, along with associated metadata identifying the speaker, is then provided as a prompt to an AI agent, such as an LLM. To manage simultaneous conversations, the system maintains a separate conversational context for each user. This allows the AI agent to process each query independently and generate a distinct, contextually appropriate response for each individual without confusing the different dialogues. In some implementations, this processing may occur within a split computing architecture, where the wearable device transmits the audio or transcribed text to a more powerful remote server or a connected companion device for execution of the AI model. The generated responses are then sent back to the wearable device for output.

Method 600 further includes distributing the determined responses to each corresponding user in the set of users at step 603. This distribution can be governed by an output management service or application running on the device's processor, which uses the directional data for each user, determined in a previous step, to create a specific audio configuration for each response. For a response intended for the wearer, the system identifies the user based on their known, proximate location and routes the audio to internal speakers, providing a private listening experience. For a response intended for a bystander, the system uses the specific directional coordinates calculated for that user. In this case, the audio configuration engages the external speakers and employs audio beamforming technology. This process electronically steers the sound waves from the external speakers to create a focused beam of audio directed precisely toward the bystander's location. This targeted delivery enhances clarity for the intended recipient while active noise cancellation is applied to minimize the audibility of the response for other users, thereby ensuring each user receives only their corresponding response and enabling simultaneous, distinct conversations.

In some implementations, a system can use noise cancelling to prevent unwanted audio from being delivered to users other than an intended user. The noise cancellation can be implemented using an active noise cancellation (ANC) system that leverages the device's microphone and speaker arrays. For instance, when the system delivers an audio response to a bystander using the external speakers, the inward-facing microphones can be used as error microphones to capture the portion of that audio that leaks toward the wearer's ears. The device's processor or a dedicated digital signal processor (DSP) analyzes this unwanted sound in real-time and generates a corresponding anti-phase sound wave, which is an inverted version of the leaked audio. This anti-phase signal is then played through the internal speakers, causing destructive interference that effectively cancels out the bystander's response for the wearer. Conversely, the same principle can be applied to protect the privacy of the wearer's interactions. When the wearer receives a private audio response through the internal speakers, the outward-facing microphones can detect any sound leakage, and the external speakers can be used to generate a localized cancellation field, minimizing what a nearby bystander can overhear. This bi-directional noise cancellation is integral to maintaining separate and clear conversational threads for each user.

In some implementations, noise cancellation can be an audio processing technique that actively reduces the audibility of a sound for a non-intended listener by generating a second sound specifically designed to destructively interfere with the first. In some implementations, noise cancellation can refer to a method of creating a zone of acoustic quiet for a user by using one or more microphones to detect unwanted sound and one or more speakers to emit an anti-phase signal that attenuates the unwanted sound. In some implementations, noise cancellation can include any process, including active noise cancellation, that manipulates audio output signals to prevent a response intended for one user from being clearly perceived by another user in the vicinity.

In some implementations, responses can be provided to multiple users. This can be triggered by several conditions. One condition is an explicit instruction within a user's request, such as a user stating, “Tell me and user B the weather forecast.” In this scenario, the AI agent parses the request to identify all intended recipients. The system then determines an audio configuration that uses audio beamforming to create multiple, distinct sound beams, directing the same response simultaneously to the calculated locations of both the original user and the other specified user. Another condition can be based on contextual information available to the AI agent. For example, if the system has identified a group of users as belonging to a specific team or family, a query from one member related to shared information could cause the system to automatically deliver the response to all identified members of that group. The system can also be configured to relay information; for example, a response delivered privately to the wearer can then be output via external speakers to a bystander who asked the original question or to a larger group.

FIG. 7 illustrates a computing system 700 to manage voice requests according to an implementation. Computing system 700 represents any computing device or devices with which the various operational architectures, processes, scenarios, and sequences disclosed herein for managing content displayed by an XR device can be implemented. Computing system 700 is an example of an XR device, head-mounted device, or some other wearable computing device in some examples. Computing system 700 can include other computing devices in some examples (e.g., desktop computers, smartphones, or other companion devices). Computing system 700 includes storage system 745, processing system 750, communication interface 760, and input/output (I/O) device(s) 770. Processing system 750 is operatively linked to communication interface 760, I/O device(s) 770, and storage system 745. In some implementations, communication interface 760 and/or I/O device(s) 770 may be communicatively linked to storage system 745. Computing system 700 may further include other components, such as a battery and enclosure, that are not shown for clarity.

Communication interface 760 comprises components that communicate over communication links, such as network cards, ports, radio frequency, processing circuitry, software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format—including combinations thereof. Communication interface 760 may be configured to communicate with external devices, such as servers, user devices, or some other computing device.

I/O device(s) 770 may include computer peripherals that facilitate the interaction between the user and computing system 700. Examples of I/O device(s) 770 may include keyboards, mice, trackpads, monitors, displays, printers, cameras, microphones, external storage devices, sensors, and the like.

Processing system 750 comprises microprocessor circuitry (e.g., at least one processor) and other circuitry that retrieves and executes operating software (i.e., program instructions) from storage system 745. Storage system 745 may include volatile and nonvolatile, removable, and non-removable media implemented in any method or technology for storage of information, such as computer-readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 750 is typically mounted on a circuit board that may hold the storage system. The operating software of storage system 745 comprises computer programs, firmware, or other forms of machine-readable program instructions. The operating software of storage system 745 comprises response application 724. The operating software on storage system 745 may further include an operating system, utilities, drivers, network interfaces, applications, or other software. When read and executed by processing system 750, the operating software on storage system 745 directs computing system 700 to operate as an XR computing device and display content as described herein. The operating software can provide the operations described in FIGS. 1-6 in at least one implementation.
Clause 1. A method comprising: receiving, by at least one audio input device on a wearable device, audio from a user; determining a direction associated with the user relative to the wearable device based on the audio; determining a response to the audio; determining an audio configuration for at least one audio output device on the wearable device based on the direction; and providing, by the at least one audio output device, the response to the user based on the audio configuration.
Clause 2. The method of clause 1, wherein the user comprises a first user of a set of users for the wearable device, and wherein the audio configuration primarily directs the response toward the first user of the set of users.
Clause 3. The method of clause 2, wherein the audio configuration applies noise cancellation for a second user in the set of users.
Clause 4. The method of clause 3, wherein the second user is a wearer of the wearable device.
Clause 5. The method of clause 3, wherein neither the first user nor the second user is a wearer of the wearable device.
Clause 6. The method of clause 1, wherein the audio configuration comprises a first audio configuration, and the method further comprising: receiving, at the wearable device, second audio from a second user; determining a second direction associated with the second user relative to the wearable device based on the second audio; determining a second response to the second audio from the second user; determining a second audio configuration for the at least one audio output device on the wearable device based on the second direction, the second audio configuration different from the first audio configuration; and providing, by the at least one audio output device, the second response to the second user based on the second audio configuration.
Clause 7. The method of clause 6, wherein the first audio configuration uses spatial audio to primarily direct the response to the user, and wherein the second audio configuration uses spatial audio to primarily direct the response to the second user.
Clause 8. The method of clause 1, wherein determining the response to the audio from the user comprises: determining text associated with the audio; communicating the text associated with the audio to a service; and receiving the response from the service.
Clause 9. A computing system comprising: a computer-readable storage medium; at least one processor operatively coupled to the computer-readable storage medium; and program instructions stored on the computer-readable storage medium that, when executed by the at least one processor, direct the computing system to perform a method, the method comprising: receiving, by at least one audio input device on a wearable device, audio from a user; determining a direction associated with the user relative to the wearable device based on the audio; determining a response to the audio; determining an audio configuration for at least one audio output device on the wearable device based on the direction; and providing, by the at least one audio output device, the response to the user based on the audio configuration.
Clause 10. The computing system of clause 9, wherein the user comprises a first user of a set of users for the wearable device, and wherein the audio configuration primarily directs the response toward the first user of the set of users.
Clause 11. The computing system of clause 10, wherein the audio configuration applies noise cancellation for a second user in the set of users.
Clause 12. The computing system of clause 11, wherein the second user is a wearer of the wearable device.
Clause 13. The computing system of clause 11, wherein neither the first user nor the second user is a wearer of the wearable device.
Clause 14. The computing system of clause 9, wherein the audio configuration comprises a first audio configuration, and the method further comprising: receiving, at the wearable device, second audio from a second user; determining a second direction associated with the second user relative to the wearable device based on the second audio; determining a second response to the second audio from the second user; determining a second audio configuration for the at least one audio output device on the wearable device based on the second direction, the second audio configuration different from the first audio configuration; and providing, by the at least one audio output device, the second response to the second user based on the second audio configuration.
Clause 15. The computing system of clause 14, wherein the first audio configuration uses spatial audio to primarily direct the response to the user, and wherein the second audio configuration uses spatial audio to primarily direct the response to the second user.
Clause 16. The computing system of clause 9, wherein determining the response to the audio from the user comprises: determining text associated with the audio; communicating the text associated with the audio to a service; and receiving the response from the service.
Clause 17. A computer-readable storage medium having program instructions stored thereon that, when executed by at least one processor, direct the at least one processor to perform a method, the method comprising: receiving, by at least one audio input device on a wearable device, audio from a user; determining a direction associated with the user relative to the wearable device based on the audio; determining a response to the audio; determining an audio configuration for at least one audio output device on the wearable device based on the direction; and providing, by the at least one audio output device, the response to the user based on the audio configuration.
Clause 18. The computer-readable storage medium of clause 17, wherein the user comprises a first user of a set of users for the wearable device, and wherein the audio configuration primarily directs the response toward the first user of the set of users.
Clause 19. The computer-readable storage medium of clause 18, wherein a second user in the set of users is a wearer of the wearable device.
Clause 20. The computer-readable storage medium of clause 17, wherein the audio configuration comprises a first audio configuration, and the method further comprising: receiving, at the wearable device, second audio from a second user; determining a second direction associated with the second user relative to the wearable device based on the second audio; determining a second response to the second audio from the second user; determining a second audio configuration for the at least one audio output device on the wearable device based on the second direction, the second audio configuration different from the first audio configuration; and providing, by the at least one audio output device, the second response to the second user based on the second audio configuration.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that, when executed, cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed for processing on a single computer, multiple computers at a single site, or distributed across multiple sites interconnected by a communication network.

While certain features of the described implementations have been illustrated as described herein, many modifications, substitutions, changes, and equivalents will now occur to those skilled in the art. It is therefore to be understood that the appended claims are intended to cover all such modifications and changes that fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
receiving, by at least one audio input device on a wearable device, audio from a user;
determining a direction associated with the user relative to the wearable device based on the audio;
determining a response to the audio;
determining an audio configuration for at least one audio output device on the wearable device based on the direction; and
providing, by the at least one audio output device, the response to the user based on the audio configuration.

2. The method of claim 1, wherein the user comprises a first user of a set of users for the wearable device, and wherein the audio configuration primarily directs the response toward the first user of the set of users.

3. The method of claim 2, wherein the audio configuration applies noise cancellation for a second user in the set of users.

4. The method of claim 3, wherein the second user is a wearer of the wearable device.

5. The method of claim 3, wherein neither the first user nor the second user is a wearer of the wearable device.

6. The method of claim 1, wherein the audio configuration comprises a first audio configuration, and the method further comprising:
receiving, at the wearable device, second audio from a second user;
determining a second direction associated with the second user relative to the wearable device based on the second audio;
determining a second response to the second audio from the second user;
determining a second audio configuration for the at least one audio output device on the wearable device based on the second direction, the second audio configuration different from the first audio configuration; and
providing, by the at least one audio output device, the second response to the second user based on the second audio configuration.

7. The method of claim 6, wherein the first audio configuration uses spatial audio to primarily direct the response to the user, and wherein the second audio configuration uses spatial audio to primarily direct the response to the second user.

8. The method of claim 1, wherein determining the response to the audio from the user comprises:
determining text associated with the audio;
communicating the text associated with the audio to a service; and
receiving the response from the service.

9. A computing system comprising:
a computer-readable storage medium;
at least one processor operatively coupled to the computer-readable storage medium; and
program instructions stored on the computer-readable storage medium that, when executed by the at least one processor, direct the computing system to perform a method, the method comprising:
receiving, by at least one audio input device on a wearable device, audio from a user;
determining a direction associated with the user relative to the wearable device based on the audio;
determining a response to the audio;
determining an audio configuration for at least one audio output device on the wearable device based on the direction; and
providing, by the at least one audio output device, the response to the user based on the audio configuration.

10. The computing system of claim 9, wherein the user comprises a first user of a set of users for the wearable device, and wherein the audio configuration primarily directs the response toward the first user of the set of users.

11. The computing system of claim 10, wherein the audio configuration applies noise cancellation for a second user in the set of users.

12. The computing system of claim 11, wherein the second user is a wearer of the wearable device.

13. The computing system of claim 11, wherein neither the first user nor the second user is a wearer of the wearable device.

14. The computing system of claim 9, wherein the audio configuration comprises a first audio configuration, and the method further comprising:
receiving, at the wearable device, second audio from a second user;
determining a second direction associated with the second user relative to the wearable device based on the second audio;
determining a second response to the second audio from the second user;
determining a second audio configuration for the at least one audio output device on the wearable device based on the second direction, the second audio configuration different from the first audio configuration; and
providing, by the at least one audio output device, the second response to the second user based on the second audio configuration.

15. The computing system of claim 14, wherein the first audio configuration uses spatial audio to primarily direct the response to the user, and wherein the second audio configuration uses spatial audio to primarily direct the response to the second user.

16. The computing system of claim 9, wherein determining the response to the audio from the user comprises:
determining text associated with the audio;
communicating the text associated with the audio to a service; and
receiving the response from the service.

17. A computer-readable storage medium having program instructions stored thereon that, when executed by at least one processor, direct the at least one processor to perform a method, the method comprising:
receiving, by at least one audio input device on a wearable device, audio from a user;
determining a direction associated with the user relative to the wearable device based on the audio;
determining a response to the audio;
determining an audio configuration for at least one audio output device on the wearable device based on the direction; and
providing, by the at least one audio output device, the response to the user based on the audio configuration.

18. The computer-readable storage medium of claim 17, wherein the user comprises a first user of a set of users for the wearable device, and wherein the audio configuration primarily directs the response toward the first user of the set of users.

19. The computer-readable storage medium of claim 18, wherein a second user in the set of users is a wearer of the wearable device.

20. The computer-readable storage medium of claim 17, wherein the audio configuration comprises a first audio configuration, and the method further comprising:
receiving, at the wearable device, second audio from a second user;
determining a second direction associated with the second user relative to the wearable device based on the second audio;
determining a second response to the second audio from the second user;
determining a second audio configuration for the at least one audio output device on the wearable device based on the second direction, the second audio configuration different from the first audio configuration; and
providing, by the at least one audio output device, the second response to the second user based on the second audio configuration.
